(19) United States
(12) Patent Application Publication
(10) Pub. No.: US 2014/0164260 A1
(43) Pub. Date: Jun. 12, 2014

(54) SYSTEMS AND METHODS FOR SELECTING COMPARABLE REAL ESTATE PROPERTIES

(71) Applicant: CORELOGIC SOLUTIONS, LLC, Irvine, CA (US)

(72) Inventor: Mark A. Spieckerman, Costa Mesa, CA (US)

(73) Assignee: CORELOGIC SOLUTIONS, LLC, Irvine, CA (US)

(21) Appl. No.: 14/046,097

(22) Filed: Oct. 4, 2013

Related U.S. Application Data
(60) Provisional application No. 61/735,941, filed on Dec. 11, 2012.

(51) Int. Cl. G06Q 30/02

(52) U.S. Cl. CPC G06Q 30/0278
USPC 705/306

(57) ABSTRACT

Embodiments of systems and methods can determine comparable real estate properties for use in the valuation of a subject real estate property. For example, a geographic area surrounding the subject property can be divided into smaller regions and a set of one or more regions having property characteristics that most closely match the characteristics of the subject property can be identified. Comparable properties can be selected from this set of regions rather than from the overall geographic area as a whole, which may lead to identifying better-matching comparable properties as compared to selecting comparable properties from the overall geographic area (which generally will include regions that are poor matches to the subject property).

### CROSS-REFERENCE TO RELATED APPLICATIONS

This application claims the benefit of priority under 35 U.S.C. §119(e) to U.S. Patent Application No. 61/735,941, filed Dec. 11, 2012, entitled “SYSTEMS AND METHODS FOR SELECTING COMPARABLE REAL ESTATE PROPERTIES,” which is hereby incorporated by reference herein in its entirety.

### BACKGROUND

1. Field

The present disclosure relates to selecting comparable real estate properties for use in making automated valuations of real estate properties.

2. Description of Related Art

To determine an estimated valuation for a real estate property (e.g., a fair market value), real estate professionals can analyze recent sales of properties that have characteristics (e.g., size, style, age, location, etc.) that are comparable to the subject real estate property. The sales prices of such comparable properties (often called “comps”) can be good indicators of the valuation for the subject real estate property.

Property valuations made by real estate professionals are subject to the qualifications, experience, and biases of the real estate professional and can take significant time to prepare. Automated Valuation Models (AVMs) are computerized systems that can provide a valuation for a property based on sophisticated mathematical and statistical modeling that takes into account, for example, characteristics, prices, and price trends of the property and comparable properties in the surrounding area or neighborhood. In addition to market sales prices, AVMs may also use information from appraisals, financing transactions, property tax assessments, etc. for the comparable properties when making the valuation for a subject property.

### SUMMARY

Accuracy of an AVM valuation of a subject real estate property can depend on identifying and selecting comparable properties in an area near the subject real estate property under evaluation. For example, the more closely the characteristics of the comparable properties match the characteristics of the property under evaluation, the more likely the resulting AVM valuation will accurately estimate the fair market value of the subject property.

Embodiments of systems and methods are described that can determine comparable real estate properties for use in the valuation of a subject real estate property. For example, a geographic area surrounding the subject property can be divided into smaller regions and a set of one or more regions having property characteristics that most closely match the characteristics of the subject property can be identified. Comparable properties can be selected from this set of regions rather than from the overall geographic area as a whole. Use of the disclosed systems and methods may lead to identifying better-matching comparable properties as compared to selecting comparable properties from the overall geographic area, which generally may include regions that are poor matches to the subject property.

Accordingly, the present disclosure describes examples of systems and methods for identifying comparable properties that more closely match a subject real estate property. Use of such comparable properties can lead to more accurate valuations of the subject real estate property.

In one implementation, a method for selecting real estate properties that are comparable to a subject real estate property is provided. The method comprises receiving information about the subject real estate property, with the information including at least a location of the subject real estate property. The method also comprises mapping a geographic area surrounding the location of the subject real estate property into a plurality of regions, determining, for each of the plurality of regions, a regional statistical characteristic of properties located in the respective plurality of regions, and determining, based at least in part on the respective regional statistical characteristics and the information about the subject property, a set of one or more regions that match the subject real estate property. The method also includes selecting comparable properties from the set of one or more matched regions and providing the selected comparable properties to an entity. The entity can be an AVM. The method can be performed in its entirety by a computer system comprising computing hardware.

In another implementation, a method for selecting real estate properties that are comparable to a subject real estate property is provided. The method comprises receiving information about the subject real estate property, with the information including at least a location of the subject real estate property. The method also comprises mapping a geographic area surrounding the location of the subject real estate property into a plurality of regions, determining, for each of the plurality of regions, a regional statistical characteristic of properties located in the respective plurality of regions, and analyzing the regional statistical characteristics to determine patterns indicative of how closely a region matches statistical characteristics of another region. The method also includes grouping the plurality of regions into one or more pattern groups based at least in part on the determined patterns, comparing the one or more pattern groups with the subject real estate property to determine a set of one or more pattern groups that most closely match the subject real estate property, selecting comparable properties from the set of one or more pattern groups that most closely match the subject real estate property, and providing the comparable properties to an entity. The entity may be an AVM. The method can be performed in its entirety by a computer system comprising computing hardware.

Other implementations include systems for selecting real estate properties that are comparable to a subject real estate property. A system can include nontransitory computer storage configured to store information about the subject real estate property, with the information including at least a location of the subject real estate property, and computer hardware configured to communicate with the nontransitory computer storage. The computer hardware can be configured with executable instructions to perform any of the methods disclosed herein.

Other implementations include nontransitory computer storage for selecting real estate properties that are comparable to a subject real estate property. The nontransitory computer storage can be configured with executable instructions that when executed by a computer system perform any of the methods disclosed herein.

Details of one or more implementations of the subject matter described in this application are set forth in the accompanying drawings and the description below. Other features, aspects, and advantages will become apparent from the description, the drawings, and the claims.

### BRIEF DESCRIPTION OF THE DRAWINGS

FIG. 1 is a block diagram that schematically illustrates an example of a system to determine a valuation for a subject real estate property. The system includes functionality to select comparable properties (“comps”) for the subject real estate property.

FIG. 2 is a flowchart that illustrates an example of a method for selecting comparable properties near a subject real estate property.

FIG. 3 is an example of a graphic showing regions mapped within a geographic area surrounding a subject real estate property (located at the center of the geographic area). In this graphic, cross-hatching is used to show regions that have statistically similar properties to each other (same style of cross-hatching) and statistically different properties from each other (different styles of cross-hatching). Regions without cross-hatching are not only statistically similar to each other but also statistically similar to the subject real estate property.

Throughout the drawings, reference numbers may be re-used to indicate correspondence between referenced elements. The drawings are provided to illustrate example embodiments described herein and are not intended to limit the scope of the disclosure.

### DETAILED DESCRIPTION

Implementations of the disclosed systems and methods will be described in the context of finding comparable properties to residential real estate properties such as homes (e.g., single-family homes, multi-family dwellings, etc.), condominiums, townhouses or town homes, and so forth. This is for purposes of illustration and is not a limitation. For example, implementations of the disclosed systems and methods can be used to find comparable properties to commercial property developments such as office complexes, industrial or warehouse complexes, retail and shopping centers, and apartment rental complexes. In addition, although the comparable properties found by various implementations of the systems and methods described herein can be used by AVMs to provide automated valuations, the comparable properties can also be provided to and used by real estate brokers, real estate appraisers, and the like to perform manual valuations of a subject property.

### Example Real Estate Property Valuation System

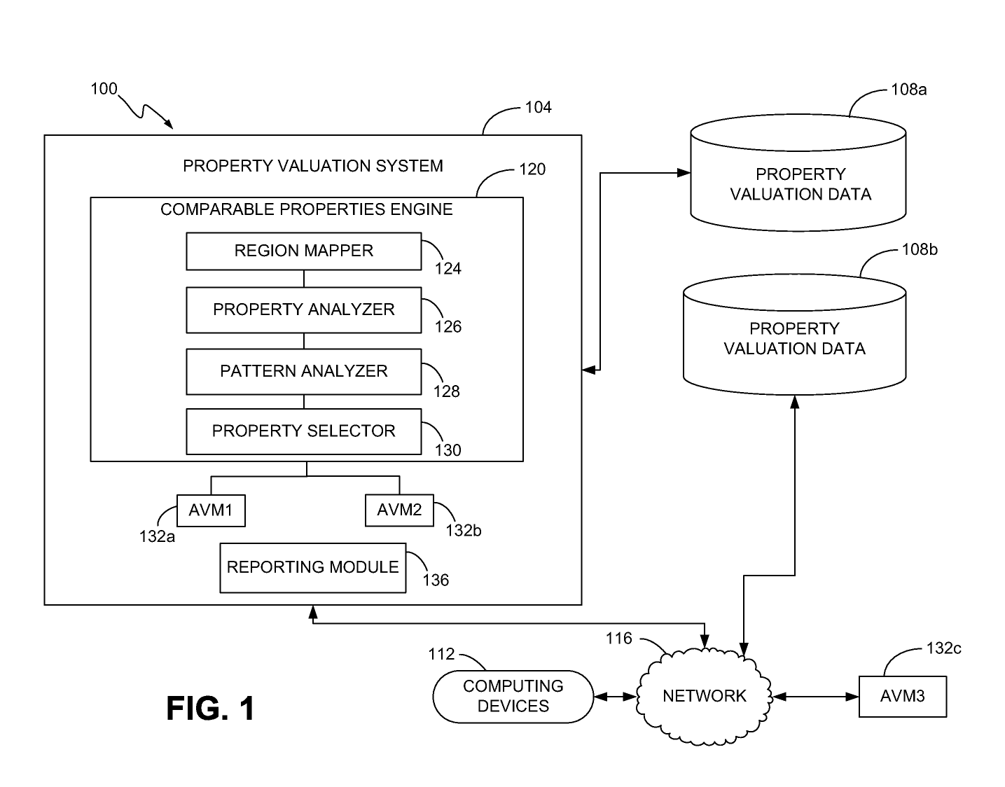

FIG. 1 is a block diagram that schematically illustrates an example of a system 100 to determine a valuation for a real estate property. The example system 100 includes a property valuation system 104 that can be hosted or implemented on one or more physical computing systems such as computer servers. The valuation system 104 can be in communication with one or more data stores 108a, 108b that store property valuation data (described further below) used to identify comparable properties and determine the valuation of the subject real estate property. The data stores 108a, 108b can be implemented on any type of computer storage medium. Some of the data stores can be local to the property valuation system 104 (e.g., the data store 108a) and other data stores may be remotely connected to the system 104 through a network 116 (e.g., the data store 108b). For example, the property valuation system 104 may access property valuation data from third-party data providers via the network 116. Although the example system 100 in FIG. 1 shows two data stores 108a, 108b, any number of data stores (e.g., 1, 3, 4, 5, or more) can be used.

One or more computing devices 112 can communicate with the property valuation system 104 over the network 116. A user of the system 100 can use one of the computing devices 112 to request or access various information from the system 100 including information related to a valuation of a particular property (e.g., lists of comparable properties, property valuations, information from the data stores 108a, 108b, and so forth). The computing devices 112 can include general purpose computers, data input devices (e.g., terminals or displays), web or application interfaces, portable or mobile computers, laptops or tablets, smart phones, etc. The network 116 can provide wired or wireless communication between the computing devices 112 and the property valuation system 104. In some implementations, the data stores 108a, 108b can communicate with the valuation system 104 (and/or the computing devices 112) over the network 116. The network 116 can be a local area network (LAN), a wide area network (WAN), the Internet, an intranet, combinations of the same, or the like. In certain embodiments, the network 116 can be configured to support secure shell (SSH) tunneling or other secure protocol connections for the secure transfer of data between the property valuation system 104, the computing devices 112, and/or the data stores 108a, 108b.

In the embodiment illustrated in FIG. 1, the property valuation system 104 includes a comparable properties engine 120 configured to identify properties having comparable characteristics to a subject property. As will be described in more detail below, the comparable properties engine 120 includes a region mapper 124, a property analyzer 126, a pattern analyzer 128, and a property selector 130. The property valuation system 104 can also include a reporting module 136 that performs reporting, auditing, and other communication functions with managers and users of the system 100. The comparable properties engine 120 can use property valuation data from the data stores 108a, 108b to identify and select properties that are comparable in characteristics to a subject real estate property for which a valuation has been requested.

a. Examples of Property Valuation Data

The property valuation data for a subject real estate property as well as properties in the general vicinity of the subject property can be stored in and accessed from the data stores 108a, 108b

As described further below, the property valuation data can include property specific characteristics such as the type of property (e.g., single family residence, condominium, town home, commercial property, etc.), characteristics of the property (e.g., the number of bedrooms and bathrooms for a single family residence or the number of leasable units in a commercial property, whether improvements have been made to the property, the date the property was constructed, etc.), geographic information (e.g., the address or zip code of the property), and the quality of the property (e.g., as determined by a physical inspection). The property valuation data can also include information on prior or current sale prices, listing prices, appraisals or other valuations, the assessed value of the property, information on prior or current loans secured by the property, the nature of the loans (e.g., whether for purchase or for refinance), and so forth.

The property characteristics can include the property's location, which can be identified by street address, geospatial coordinates (e.g., geocodes), or latitude and longitude of the property. The property characteristics can also include a physical description of the property. For example, the physical description can include lot size (e.g., entered as width and length or dwelling per acre), gross living area (GLA), bedroom count, bathroom count, number of floors, stories, or levels (e.g., basement), garage description (e.g., garage space, whether one-car or multiple-car), whether the property has a heater or air conditioner, whether the property has any property-specific amenities such as its own pool or spa, and so forth. The property characteristics can include property type (e.g., single family dwelling, condominium, town home), date of construction or improvement, etc.

The property characteristics can also include information on features of the surrounding area that can influence property value. Examples of such features that tend to positively influence value are scenic views, golf courses, swimming pools, parks, schools, day care centers, presence of gates (manned or unmanned), etc. Examples of features that tend to negatively influence value are close proximity to highways, railroads, telephone lines or electrical power lines, poor performing schools, close proximity to high crime areas, etc.

In some implementations, such data can be acquired via geospatial geographic information systems (GIS), via user input, or other data sources. Multiple listing service (MLS) listing information can be accessed to provide information on how long properties in the surrounding area have been for sale and changes to the asking price. MLS data may also include months of supply and market inventory. In some implementations, the system 100 can access MLS data (e.g., over the network 116) from services that use the Real Estate Transaction Standard (RETS), which provides a common standard for MLS data exchange between computing systems. The system 100 additionally or alternatively can access machine-readable versions of MLS information (or other information). For example, the machine-readable version can include an extensible markup language (XML) version of fields in MLS listings. Other information that can be used includes sales transaction history by price for properties in the surrounding area can be used, the share (or percentage) of properties with positive equity or negative equity, etc.

The property valuation data can include information about the real estate market in the neighborhood or area in the vicinity of the property including the volume of recent property transactions, homogeneity of the housing stock, property valuation trends (e.g., whether the local market is appreciating or depreciating), rates of delinquency, foreclosures, refinances, or short sales, etc. MLS listing information can indicate how long properties in the surrounding area have been for sale and changes to the asking price for the properties. MLS listing information may also include months of supply and market inventory.

Some implementations of the system 100 can adjust valuations for properties (e.g., recent sales prices) so that the valuations are representative of a target valuation date. Such implementations may be advantageous where prices are appreciating or depreciating significantly, so that the adjusted valuations (some or all having the same or similar target valuation date) may be more reliably compared with each other. Accordingly, the property valuation data can also include scores or metrics reflecting property values, sales demand, or sales propensity. For example, in certain embodiments, the property valuation data can include the HomeStandings Score, which grades the relative strengths and weaknesses of the localized market, the Home Price Index (HPI) and/or HPI Forecast, which forecast home price trends, market volatility and elasticity, and information from the Negative Equity Report, which estimates equity and negative equity shares and trends for single-family residential properties. The foregoing scores and forecasts are available from CoreLogic (Irvine, Calif.). The property valuation data can also include information on distressed transactions, real estate owned (REO) transactions, foreclosures, and loan delinquency. Other data sources providing information on market demand, historical price trends, and future market trends can be accessed and analyzed for use in the valuations or sales forecasts for the development. Some implementations may also adjust property valuations based, at least partly, on other property characteristics such as GLA or lot size.

b. Examples of Systems for Identifying Comparable Properties

As further described in detail herein, the comparable properties engine 120 can divide the geographic area near the subject property into smaller regions and identify a set of one or more of these regions having property characteristics that most closely match the characteristics of the subject property. The engine 120 can select comparable properties from this set of regions and be more likely to identify better-matching comparable properties as compared to selecting comparable properties from the overall geographic area (which generally may include regions that are poor matches to the subject property).

The comparable properties engine 120 can access the property valuation data in data stores 108a or 108b to search for and identify properties in the geographic location of a subject property that have property characteristics similar to the subject property and which have recent sales transactions (or other valuation (s)). In the embodiment illustrated in FIG. 1, the comparable properties engine 120 includes the region mapper 124, the property analyzer 126, the pattern analyzer 128, and the property selector 130. This separation of functionalities is for purpose of illustration and is not intended to be limiting. The comparable properties engine 120 can be configured differently in other embodiments.

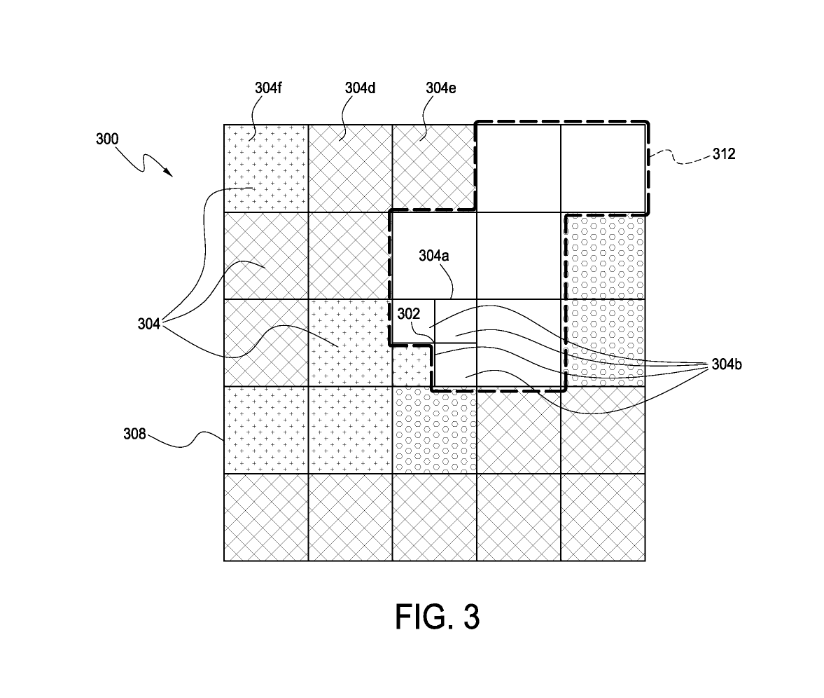

In certain implementations, the comparable properties engine 120 selects comparable properties by dividing the area surrounding the subject property into multiple regions. These regions can, but need not, be polygons (e.g., triangles, squares, rectangles, pentagons, hexagons, etc.). The multiple regions can be non-overlapping and can fill the area around the subject property without gaps (see, e.g., the example shown in FIG. 3). Since the overall property characteristics of each of the regions can be different, the comparable properties engine 120 can analyze each of these regions to identify value and/or characteristic patterns in the overall geographic area near the subject property. These patterns can be used with the subject's property characteristic, transactions (e.g., previous sales prices), and location information to match the subject property with comparable properties selected from the most closely-matching regions. Using comparable properties from the regions that most closely match the subject property can result in identifying and selecting comparable properties that more closely match the subject property itself. By finding better property matches (e.g., better “comps”), the property valuation system 104 can generate a more accurate valuation result for the subject property.

In some implementations, the comparable properties engine 120 dynamically looks for patterns of similar properties in regard to value/characteristics. As an example, the engine 120 may exclude inland comparable properties for a subject property that is on a coastline. As another example, the engine 120 may be able to dynamically section out different housing tracts based on each tract's characteristics.

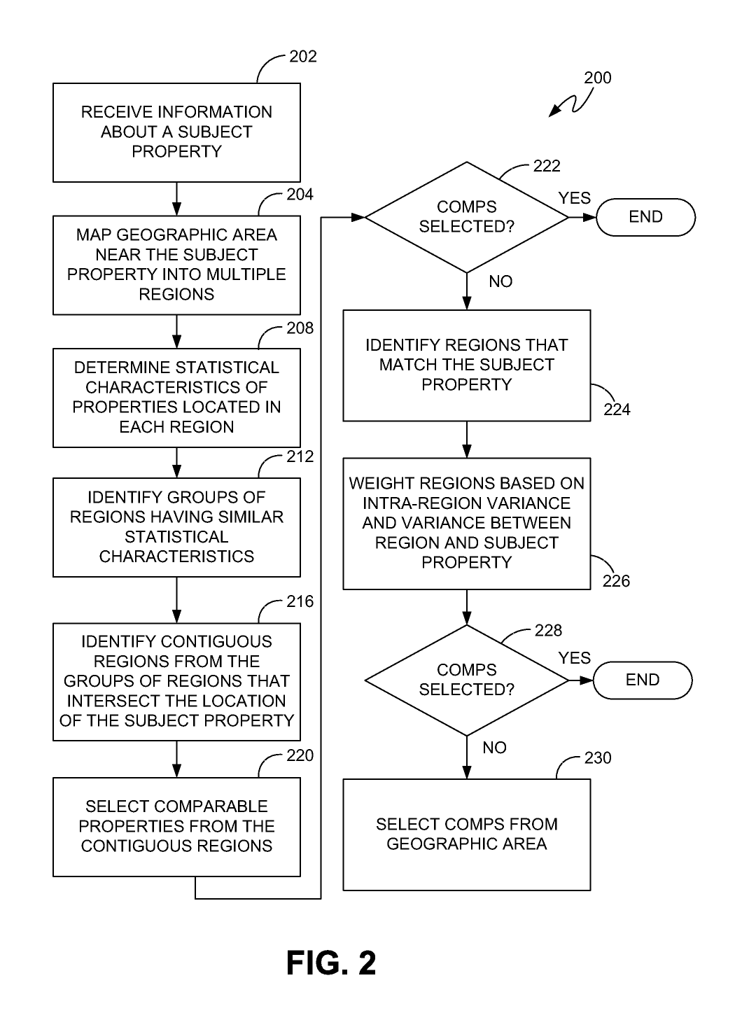

Examples of methods implemented by the comparable properties engine 120 are described below with reference to FIG. 2. As a general overview of one example implementation, the region mapper 124 can be used to map the geographic area near the subject property into a plurality of smaller, non-overlapping regions that fill the geographic area around the subject property without gaps between adjacent regions (e.g., to avoid missing potential comparable properties). An example of multiple regions mapped around a subject property is schematically illustrated in FIG. 3, described below. The property analyzer 126 can determine and analyze statistical characteristics of real estate properties in each of the regions. For example, the property analyzer 126 can determine a mean, median, mode, skewness, and/or variance of property characteristics in each region. The property characteristics can include any type of property information available from the data stores 108a, 108b such as recent sale or listing prices, prices adjusted to a target valuation date, gross living area, lot size, price per square foot (based on lot or GLA size), assessed value, year built, number of bedrooms/bathrooms, improvements, amenities, etc.

The pattern analyzer 128 can analyze the statistical characteristics of the regions determined by the property analyzer 126. For example, the pattern analyzer 128 can compare nearby or adjacent regions to search for and identify value patterns such as regions in which one or more of the statistical characteristics are similar to each other (e.g., similar sales prices, homes with similar number of bedrooms/bathrooms and amenities, etc.). The greater the number of statistical characteristics that match, the more likely it is that there is a pattern between the regions. In some cases, the pattern analyzer 128 can generate a score for each region (e.g., a weighted sum of various statistical characteristics) and compare scores between regions to identify regions in which there are statistical patterns (e.g., a likelihood that properties in the region have similar characteristics to the subject property). In some implementations, the pattern analyzer can group the regions into one or more pattern groups based at least in part on the determined patterns. A pattern group can include one, two, three, or more regions for which a statistical pattern has been found such as, the regions in the pattern group having one or more statistical characteristics that are similar to each other.

The property selector 130 can use the value patterns (and/or pattern groups) and statistical characteristics determined by the property analyzer 126 and the pattern analyzer 128 to determine a set of one or more regions (or pattern groups) that match with the characteristics of the subject property. Properties that are located in the set of regions (or the pattern groups) have the closest match to the characteristics of the subject property. These properties can be identified as the best-matching comparable properties and can be used by the AVMs 132a-132c to value the subject property. The properties that are not located in this set of regions (or in the pattern groups) likely match less closely with the characteristics of the subject property. Thus, such properties can be excluded (or included with lower weight) from use in valuing the subject property. In some cases, the property selector 130 identifies the set of regions (or pattern groups) that most-closely match the subject property by searching for a contiguous group of regions that include (e.g., intersect with) the region containing the subject property and which have value patterns that match the subject property.

The set of properties selected by the property selector 130 can be provided to the AVMs 132a-132c, reported by the reporting module 136 to a user or requestor or other entity (e.g., a lender), or stored in the data stores 108a, 108b for use by other AVMs, entities, or real estate professionals. The set of properties can be provided as a list (optionally with associated property characteristics). The reporting module 136 can also optionally report the value characteristics, statistical information, or value patterns determined by the property analyzer 126 or the pattern analyzer 128. In some cases, the reporting module 136 can output a graphic, such as the example shown in FIG. 3, showing the polygons mapped by the region mapper 124. In some such cases, the polygons can be colored or shaded to represent, for example, closeness of match of the properties in the polygon to the subject real estate property.

The nature of the geographic area of a subject real estate property can influence search parameters used in the searches for comparable properties by the comparable properties engine 120. For example, the search parameters can include distance from the subject property and how far back in time to search for relevant transactions. In some embodiments, an initial search is performed with relatively small distance or time parameters, and if too few relevant transactions are found, the extent of the search parameters can be increased and the search broadened until sufficient comparable properties are found for an AVM valuation to be performed. The number of comparable properties needed for the AVM valuation to be reliably performed can depend on the individual characteristics of the AVM. In some cases, the AVM may utilize a certain number of “comps” to generate a valuation having a particular certainty (e.g., measured by a forecast standard deviation (FSD)). Increasing the number of “comps” provided to the AVM may allow the AVM to generate a more accurate valuation for the subject property. Accordingly, the search can be broadened (or narrowed) so as to select an appropriate number of comparable properties to achieve a valuation with a desired or required certainty.

c. Examples of Automated Property Valuation

The property valuation system 104 can access property characteristics about the subject real estate property and other properties from the data stores 108a, 108b. The comparable properties engine 120 will attempt to find nearby properties which have characteristics that are a reasonable match to the property characteristics of the subject property. Based at least partly on the comparable properties found by the comparable properties engine 120, a valuation for the subject property can be determined by one or more automated valuation models (“AVMs”) 132a, 132b, and 132c. Generally, an AVM is a computerized system that can provide a valuation for a property (e.g., an estimate of a fair market value for the property) based on a mathematical model that takes into account, for example, characteristics of the subject property, characteristics of the comparable properties, including (but not necessarily limited to) those selected by the comparable properties engine 120, and price trends of the property and the surrounding area or neighborhood. In the system 100, the AVMs 132a-132c can access property valuation data as needed from the data stores 108a, 108b and a selection of comparable properties from the comparable properties engine 120. The AVMs 132a-132c can calculate estimates for the valuation of the subject property.

One or more of the AVMs may be integrated with or local to the property valuation system 104 (e.g., AVM1 132a and AVM2 132b) and/or remotely accessed over the network 116 (e.g., AVM3 132c). The valuation system 104 can use proprietary AVMs and/or third party AVMs (e.g., AVM3 132c could be an operated by a third-party unaffiliated with the property valuation system 104). Although a single AVM can be used, in some implementations multiple AVMs are used to provide better estimates (or ranges of estimates) for the subject property valuation. For example, multiple AVM valuations can be determined for the property, and the valuation provided by the valuation system 104 can be an average of the multiple AVM valuations. In some cases, a weighted average can be used, with the weight of an individual AVM valuation based at least partly on an accuracy estimate for the AVM valuation (e.g., a forecast standard deviation for the AVM). Examples of AVMs usable with various embodiments of the system 100 include, but are not limited to, the ValuePoint4 AVM, the Home Price Analyzer (HPA) AVM, the PowerBASE6 AVM, and the PASS AVM, all available from CoreLogic (Irvine, Calif.), and the Home Value Explorer (HVE) AVM available from Freddie Mac (McLean, Va.).

The reporting module 136 can report the property valuation, the list of comparable properties found by the comparable properties engine 120, or other property characteristic data to a user or to one or more of the data stores 108a, 108b for archival storage.

In some cases, a real estate professional (e.g., a broker or appraiser), a lender, or financial institution may desire only to obtain a list of comparable properties for a subject property (and not desire to obtain an AVM valuation). For example, the real estate professional may perform an in-person inspection of the subject property and request (e.g., using a computing device 112) a list of comparable properties for use in the real estate professional's own personal evaluation. As another example, a lender may wish to obtain a valuation from a party unaffiliated with the system 100 (e.g., using the AVM3 132c) but have that valuation be based on the list of comparable properties generated by the comparable properties engine 120. In such cases, the system 100 may identify a list of comparable properties to a subject property, and the reporting module 136 can communicate the list to the requestor (e.g., via the network 116).

d. Examples of Additional Features

The property valuation system 104 can optionally be configured to include additional or alternative features. For example, in some embodiments, the property valuation system 104 can analyze the property characteristics accessed from the data stores 108a, 108b to check for errors or inconsistencies in the property valuation data. By identifying (and/or correcting) such errors or inconsistencies, the system 100 can select more representative comparable properties and provide more accurate valuations. The system 104 may analyze conformity of a particular property's characteristics relative to characteristics of properties in the surrounding area or neighborhood or to sales comparables, and MLS listing information to identify possible errors or inconsistencies in the characterization of the particular property. For example, the system 104 may check some or all data fields for a particular property for reasonableness of the data entered in the field. Examples of questionable or unreasonable data inputs include a lot that has been input as having 3,000 square feet with a home having a size of 15,000 square feet, or a home having a size of 1,250 square feet with 10 bathrooms. The system 104 may attempt to determine various other types of errors such as whether a property zip code is in a standardized format provided by the United States Postal Service, whether the properties are located outside of a geographic location for which the system can access property valuation data, and whether the properties are in a geographic location that is difficult to value. For example, certain rural areas or extremely high-end custom areas can be difficult to value. Properties with poor sales comparable data or serious characteristic data deficiencies can also be included in this category.

In some implementations, the property valuation system 104 may communicate an error notification (e.g., an electronic mail, text message, or other type of report or log) to a user or system administrator if an error is found. For example, the notification may indicate that the user/administrator should check the fields identified as unreasonable and re-enter the data, if necessary. In some such cases, the valuation system 104 may halt further processing until the questionable fields have been re-entered and subsequently reconciled as being reasonable. In other cases, the valuation system 104 may continue processing after automatically modifying questionable fields to have default parameters (e.g., rather than 10 bathrooms, a single bathroom could be assumed). A user or administrator could check an error log(or an error section of a valuation report provided by the reporting module 136) to determine which fields may be questionable, and if the default parameters were unreasonable, the user or administrator could update the fields and re-run the valuation.

### Example Real Estate Development Valuation Methods

FIG. 2 is a flowchart that illustrates an example of a method 200 for selecting comparable properties near a subject real estate property. The method 200 can be performed by the comparable properties engine 120 of the property valuation system 120.

At block 202, information about a subject property is received. The information can include property characteristics of the subject property received from the data stores 108a, 108b. The information can include location of the subject property, which can be identified by street address, geospatial coordinates (e.g., geocodes), or latitude and longitude of the property. The property characteristics can also include a physical description of the subject property including lot size, gross living area (GLA), bedroom count, bathroom count, number of floors, stories, or levels (e.g., basement), garage description, whether the property has a heater or air conditioner, whether the property has any property-specific amenities such as its own pool or spa, and so forth. The property characteristics can include property type (e.g., single family dwelling, condominium, town home), date of construction or improvement, and information on features of the surrounding area that can influence property value (either in a positive or negative way).

At block 204, the method 200 can map the geographic area surrounding the subject property into multiple regions. In some implementations, the region mapper 124 performs block 204. FIG. 3 is an example of a graphic 300 showing regions 304 (squares in this example) mapped in the geographic area 308 near the subject real estate property (at the center 302 of the graphic 300). The geographic area 308 in the example in FIG. 3 is shown as a square, however this is intended for illustrative purposes. In other cases, the geographic area can be a polygon, circle, oval, or other shape. The subject property can, but need not, be located at the center 302 of the geographic area 308.

The geographic area 308 around the subject property can be set to have a default size (e.g., a width and/or height of a square or rectangular area or a diameter or radius of a circular area). For example, the default size can be 0.25 miles, 0.5 miles, 1.0 mile, or some other size. In some embodiments, the size of the geographic area 308 can be set dynamically. For example, the method 200 can receive information on the number of recent property sales in the default-sized geographic area 308. If the number of recent sales is too low (e.g., below a threshold), the size of the geographic area 308 can be increased until the number of recent sales in the geographic area exceeds the threshold. Conversely, if the number of recent sales is too high (e.g., above the threshold), the size of the geographic area 308 can be decreased until the number of recent sales in the geographic area is below the threshold. In some implementations, the default size of the geographic area is 0.5 miles, and the threshold is 150 recent sales. In some implementations, the time period over which sales are considered “recent” can be within 90 days. The time frame can be increased (e.g., to 6 months) or decreased depending in part on the sales activity in the geographic area.

Continuing with block 204, the geographic area near the subject property can be divided into multiple regions. The number of regions can be, for example, 2, 3, 4, 5, 9, 12, 16, 20, 25, 36, or some other number. In some implementations, the multiple regions can be non-overlapping and selected to fill the area around the subject property without gaps between the regions. In the example in FIG. 3, the geographic area 308 is initially divided into a 5×5 grid of 25 equally sized regions 304. The grid of regions can be oriented along compass directions (e.g., North (N)-South (S) and/or East (E)-West (W)). One or more of the regions can be subdivided into additional regions. For example, in some implementations, the central region 304a surrounding the subject property is subdivided into smaller regions 304b (e.g., quadrants in this example) leading to a total of 28 regions within the geographic area 308. Thus, in this example, the initial polygon (e.g., square) surrounding the subject property is divided into four quadrants. Surrounding this initial polygon are eight polygons in eight compass directions (N, NE, E, SE, S, SW, W, NW), and beyond this are a set of sixteen polygons. In other implementations, the sizes of the regions can continue to increase with distance away from the subject property. Using smaller sized regions near the subject property advantageously may help identify trends in property characteristics close to the subject property.

The regions can have any suitable shape such as polygons (e.g., triangles, squares, rectangles, pentagons, hexagons, etc.), circles, ovals, or other shape having straight and/or curved sides. Block 204 of the method 200 can use any tiling or tessellation algorithm to map the geographic area surrounding the subject property into a plurality of regions.

In some implementations, the number of regions in the geographic area surrounding the subject property is selected dynamically based at least partly on the number of recent sales in the geographic area. Such implementations advantageously may improve the statistical quality of the analysis by providing a statistically sufficient number of properties in each region. In some cases, one or more sales thresholds can be established, and the number of regions can be based on which sales threshold is passed. For example, if the number of recent sales is below fifty, the geographic area may be mapped into four regions (e.g., quadrants), if the number of recent sales is above 150, the geographic area may be mapped into 28 regions (e.g., as in the example in FIG. 3), and if the number of recent sales is above 500, the geographic area may be mapped into 64 regions.

At block 208, the method 200 determines statistical characteristics of the properties in each region having recent sales. These statistical characteristics can be referred to as intra-region statistical characteristics, because they reflect the statistical characteristics within a particular region. In some implementations, the property analyzer 126 performs block 208. The intra-region statistical characteristics can include the mean, median, mode, skewness, variance (or standard deviation), or other statistical values for any property characteristic. For example, intra-region statistical characteristics can be calculated for property characteristics including recent sale or listing prices, prices adjusted to a target valuation date (e.g., using HPI), gross living area (GLA), lot size, price per square foot (based on lot or GLA size), assessed value, year built, number of bedrooms/bathrooms, improvements, amenities, etc. The intra-region statistical characteristics for each region can, in some implementations, be efficiently calculated in a single loop through all the properties having recent sales in the region. Regions in which the intra-region variance is low represent areas in which the properties have generally similar characteristics. Regions in which the intra-region variance is high represent areas with a wider range or diversity of properties as compared to regions with low intra-region variance. Properties selected from regions with high intra-region variance may be poor matches to the subject real estate property, because they may be less likely to be a good substitute for the subject property. The level of intra-region variance (e.g., low, medium, high) can be determined by comparing the intra-region variance to an intra-region variance threshold such as 1%, 5%, 10%, or some other percentage of a relative or ratioed statistical characteristic (e.g., a standard deviation of the sales prices divided by the mean sales price). An illustrative example of intra-region variance is presented below.

In some implementations, for each region, one or more region scores can be calculated that are based at least partly on the intra-region statistical characteristics calculated for the region. A region score may combine (e.g., by a weighted average) a plurality of statistical characteristics of the region and may make inter-comparisons of the regions more meaningful since the region score may be more reflective of the overall property characteristics of the region than an individual statistical characteristic of the region. For example, certain AVM valuations tend to be more sensitive to GLA or lot size than the number of bedrooms/bathrooms. Thus, a region score may be weighted to reflect the greater importance of GLA and/or lot size as compared to the number of bedrooms/bathrooms. In some cases, the region score can include sales prices of the properties within the regions, because sales price may be a proxy that indicates additional features that distinguish the properties (e.g., desirable location, scenic view, gated community, etc.).

At block 212, the method 200 analyzes the statistical characteristics of different regions to identify patterns in the statistical characteristics among the regions. In some implementations, the pattern analyzer 128 performs block 212. These statistical characteristics can be referred to as inter-region statistical characteristics, because they reflect the difference between statistical characteristics of different regions. For example, two (or more) regions can be compared by calculating the statistical variance (or numerical difference) of a region score (or other statistical value) of a first region as compared to a corresponding region score (or other statistical value) of a second region (that is different from the first region). Groups of regions in which the inter-region variance is low are likely to be similar in characteristics, whereas regions in which the inter-region variance is high are likely to be dissimilar. A pattern can reflect that two or more regions have low inter-region variance(s), e.g., below an inter-region variance threshold. The inter-region variance threshold may be set as 1%, 5%, 10%, or some other percentage of a relative difference in a statistical characteristic (e.g., a region score) between different regions.

The statistical characteristics of the regions can also be compared with the property characteristics of the subject property to determine how close a match each region is to the subject property. In making this comparison, any suitable statistical characteristic or group of characteristics can be compared. For example, the weighted region score can be used to determine how closely a particular region matches the subject property (e.g., the difference is below a threshold).

Some implementations advantageously may be able to identify (and exclude as comparables) properties although having similar overall characteristics to the subject real estate property but which are nonetheless poor comparables, because they have very different prices due to other factors (e.g., desirable location, scenic view, gated community, etc.). For example, a home located near a coastline and having an ocean view may be generally similar in size and other property characteristics to an inland home located far from the coastline. Although the two homes may be generally similar in gross living area, number of bedrooms/bathrooms, etc., the price of the inland home is likely to be significantly less than the price of the home with the ocean view. The ocean-view home is likely to be a poor comparable to the inland home and vice-versa. Accordingly, in some implementations, sales prices of properties within a particular region can be compared to a prior sales price of the subject property (or a prior sales price adjusted to a target valuation date) to attempt to identify regions containing properties that are poor comparables to the subject property.

At block 212, a variance between a region and the subject property can be calculated, and if the variance is sufficiently low (e.g., below a threshold), then the region likely matches the characteristics of the subject property. Additionally, some embodiments may preferentially select regions that are not only close matches to the subject property but are also regions having low intra-region variance, which may reflect that a high percentage of the properties in the region are good matches to the subject property. In some such embodiments, regions that are close matches to the subject property may be weighted or ranked based on their intra-region variance such that regions with low intra-region variance are preferentially used in the selection of comparables.

In some implementations, a plurality of thresholds can be established to reflect the degree to which a region matches the subject property. For example, if the variance between a region and the subject property is below a first (low) threshold, there is a close match; if the variance is above the first threshold and below a second (higher) threshold, there is a less close match, and so forth. In some cases, different colors, shades, or hues (or other graphical pattern) can be set to correspond to different closeness thresholds, e.g., green represents a close match to the subject property, yellow represents an intermediate match, and red represents a remote or distant match. The example graphic 300 in FIG. 3 can be marked (e.g., by coloring, shading, or cross-hatching) to provide a pictorial illustration of the patterns and trends in the geographic area surrounding the subject property. For example, the properties in the region 304d are statistically similar to the properties in the region 304e (e.g., the statistical variance between the regions 304d and 304e is sufficiently small). Therefore, in the graphic 300, the regions 304d and 304e are marked similarly to each other (e.g., with the same style of cross-hatching). The properties in the region 304f are statistically dissimilar to the properties in either of the regions 304d or 304e (e.g., the statistical variance between the region 304f and the regions 304d and 304e is sufficiently large). Therefore, in the graphic 300, the region 304f is marked differently from the regions 304d and 304e (e.g., with different cross-hatching). The reporting module 136 can provide the graphic 300 to users of the system 100.

At block 216, the method 200 can analyze the patterns among the regions and the subject property to identify contiguous regions having similar characteristics and that also intersect the location of the subject property. In some implementations, the pattern analyzer 128 also can perform block 216. The contiguous regions having similar characteristics can be determined from the patterns found at block 212. In some implementations, regions with low intra-region variance are preferentially selected for analysis (as compared to regions with high intra-region variance), because low intra-region variance more likely indicates that the region has more uniform property characteristics. The group regions with low intra-region variance can then The group of regions having a particular closeness in statistical characteristics to each other (e.g., regions with sufficiently low inter-region variance) can be analyzed to determine whether the regions are spatially adjacent to each other. Additionally, the contiguous regions can then be analyzed to determine if the contiguous region includes or intersects the subject property. For example, the contiguous regions enclosed by the dashed line 312 in FIG. 3 include or intersect with the subject property at the center 312 of the graphic 300.

The contiguous regions may be considered to be the regions that most closely match to the property characteristics of the subject property. For example, a contiguous region (e.g., the region enclosed by the dashed line 312 in FIG. 3) may represent a neighborhood where properties are not only similar to each other but also similar to the subject property. The dashed line 312 may represent a boundary to the neighborhood such that properties in the regions within the dashed line 312 are in the neighborhood and properties in regions outside the dashed line 312 are outside the neighborhood.

Properties located in the contiguous region (e.g., within the neighborhood) are likely to be the properties that a buyer would look to as substitutes for the subject real estate property. Also, if the buyer is interested in the subject property, the buyer also is more likely to be interested in other properties in the same neighborhood. Therefore, properties having recent sales that are located in the contiguous region, e.g., within the neighborhood, are likely to be the best matches as “comps” to the subject property. The boundaries to the neighborhood(s) in the geographic area 308 generally can be determined more accurately as the number of regions 304 within the geographic area 308 increases.

At block 220, the method 200 can select properties within the contiguous region(s) as the comparables to pass to an AVM (e.g., AVMs 132a-132c) for a valuation of the subject property. If, at block 222, a sufficient number of comparable properties are found, the method 200 can end.

In some cases, there may be too few recent sales in a contiguous region or even a lack of a contiguous region in the geographical area 308 for the method 200 to find a sufficient number of comps at block 220. In such cases, the method 200 can continue at block 224 to identify regions that are close matches to the subject property. In some embodiments, the method 200 may use regions that were previously identified (e.g., at block 212) as close matches to the subject property. In other embodiments, the method 200 may identify matches to the subject property by calculating a variance between a region and the subject property. If the variance is sufficiently low (e.g., below a threshold), then the region likely matches the characteristics of the subject property. In some implementations, a plurality of thresholds can be established to reflect the degree to which a region matches the subject property. For example, if the variance is below a first (low) threshold, there is a close match; if the variance is above the first threshold and below a second (higher) threshold, there is a less close match, and so forth. The variances used at block 224 may, but need not be, different from the variances used at block 212.

At block 226, the regions in the geographic area 308 can be weighted or ranked based at least in part on each region's respective variance with respect to the subject property and/or each region's intra-region variance. For example, regions that are close matches to the subject property, and which have low intra-region variance, can be weighted more highly than regions that are less close matches to the subject property and/or have higher intra-region variance. Therefore, comparable properties can be selected preferentially from the more highly weighted or ranked regions. In some implementations, if a region has low intra-region variance but the region's property characteristics different significantly from the subject property, comparables are not selected from that region. At block 228, if a sufficient number of comparable properties are selected from the weighted or ranked regions, the method 200 can end.

At block 230, if a sufficient number of comparables has not been selected at either block 222 or block 228, the method 200 may default to selecting comparable properties from the overall geographic area surrounding the subject property.

The method 200, at blocks 220, 226, 230, or prior to ending, can provide the selected properties to an entity. For example, the method 200 can communicate the selected properties to an AVM for valuation of the subject property, communicate the selected properties to a lender, real estate entity, loan provider, etc. or store the selected properties in a storage medium. The method 200 may provide to AVMs (or other property valuers or entities) not only a list of selected comparable properties for use in valuation but also a measure of the degree of closeness-of-match to the subject property (e.g., a variance) so that the AVM can take into account how closely the comparable properties match when determining a valuation of the subject property.

The method 200 described with reference to FIG. 2 is intended to be illustrative and not limiting. The various blocks shown in FIG. 2 can be rearranged, reordered, combined, merged, or eliminated. Additional blocks can be added. Further, different implementations can utilize a subset of the features of the method 200 and not utilize other features of the method. For example, in some implementations, block 216 for finding contiguous regions is not used, and the method 200 uses weighted or ranked regions as described for block 226 to select comparables. In other cases, if contiguous regions (e.g., neighborhoods) are not identified, the method 200 defaults to selecting comparable from the overall geographic area (block 230). Accordingly, many variations of the method shown and described with reference to FIG. 2 are contemplated.

### Example Implementation for Selecting Comparable Properties

An illustrative implementation of the method 200 for selecting comparable properties will now be presented. This example is intended to illustrate, but not limit, various features of the method 208. The methods and techniques described below can be implemented by the property valuation system 104 described with reference to FIG. 1.

In this example, an intra-region variance for a particular property characteristic (sometimes called a “field”) may be calculated using a standard deviation of the characteristic for properties located within the region. For example, the standard deviation s for a field x can be calculated as

$$s = \sqrt{\frac{{\sum }_{i = 1}^{n} {( {x}_{i} - \overline{x} )}^{2}}{( n - 1 )}} ,$$

where xᵢ is an individual field value, x̅ is the mean of the individual field values, and n is the number of observations of the field x. An observation of a field can represent a known, measured, calculated, or inferred value for the field. In some cases, the intra-region variance may not be calculated unless there are at least a minimum number (e.g., 6) of observations for the field. The level of intra-region variance (e.g., low, medium, high) for a field can be determined by comparing the standard deviation to a threshold value or range of threshold values for the standard deviation. For some fields, the level of intra-region variance can be measured relative to a standard deviation percentage from the mean value for the field.

Table 1 is an example of a Variance Table that shows thresholds for intra-region variances that are considered, in this example, to be low, medium, or high. For any particular region, the standard deviation of a field can be calculated and compared to the threshold ranges in Table 1 to determine whether the field is considered to have low, medium, or high variance. The threshold ranges in Table 1 are examples, and the ranges may be different in other implementations.

TABLE 1

| Field | Low | Medium | High |
|---|---|---|---|
| GLA | 0-150 | 151-250 | 251+ |
| Lot Size | 0-300 | 301-500 | 501+ |
| Number of Bedrooms | 0-0.5 | 0.51-0.75 | 0.76+ |
| Number of | 0-0.4 | 0.41-0.65 | 0.66+ |
| Bathrooms | | | |
| Sale Prices | 0%-5% | 6%-10% | 11%+ |
| Adjusted Sale Prices | 0%-5% | 6%-10% | 11%+ |
| (Adjusted by HPI) | | | |
| Year Built | 0-3 | 4-10 | 11+ |
| Price-per-square-foot | 0-15 | 16-30 | 31+ |
| Assessed Value | 0%-5% | 6%-10% | 11%+ |
| Listing Price | 0%-5% | 6%-10% | 11%+ |

In some implementations, a field can also be considered to have low variance if the value of the mode is present in a first threshold percentage (e.g., 65%) of the observations, considered to have medium variance if the value of the mode is present in at least a second threshold percentage (e.g., 50%) of the observations, and considered to have high variance if the value of the mode is present in at least a third threshold percentage (e.g., less than 50%) of the observations.

To determine intra-region variance for a region as a whole, one or more scores can be calculated based at least partly on the intra-region variance levels for one or more fields, weighting factors for the one or more fields, etc. For example, for each field, a field variance score can be calculated. In one implementation, if the field has low variance, the field variance the score=1, if the field has medium variance, the field variance score=0.5, and if the field has high variance, the field variance score=0. In this implementation, the field weightings are shown in Table 2. The field weightings can be selected so that fields that have greater importance in determining AVM valuations are given higher weight than fields that have less importance in determining AVM valuations. Other values for the field variance scores and/or field weightings can be used in other implementations.

TABLE 2

| Field | Field Weighting |
|---|---|
| GLA | 10 |
| Lot Size | 8 |
| Number of Bedrooms | 5 |
| Number of Bathrooms | 3 |
| Sale Prices | 8 |
| Adjusted Sale Prices | 10 |
| (Adjusted by HPI) | |
| Year Built | 7 |
| Price-per-square-foot | 5 |
| Assessed Value | 4 |
| Listing Price | 7 |

In an example implementation, the following scores are calculated: a size score, a value score, and an age score. The size score can be determined as (GLA variance score*GLA weight)+(Lot size variance score*Lot size weight)+(Bedroom variance score*Bedroom weight)+(Bathroom variance score*Bathroom weight). The range for the size score is between 0 and 25, and its associated size threshold score can be 15. The value score can be determined as (Sale prices variance score*Sale prices weight)+(Adjusted sale price variance score*Adjusted sale price weight)+(Assessed value variance score*Assessed value weight)+(Listing price variance score*Listing price weight)+(Price-per-square-foot variance score*Price-per-square-foot weight). The range for the value score is 0 to 34, and its associated value threshold score can be 15. The age score can be determined as (Year built variance*Year built weight). The range for age score is 0 to 7 and its associated age threshold score can be 5.

The total of the scores (e.g., the sum of the size score, the value score, and the age score), and the total of the associated threshold scores (e.g., the sum of the size threshold score, the value threshold score, and the age threshold score) can be calculated. If the total of the scores exceeds the total of the associated thresholds, the region can be considered to have low variance. In some implementations, certain intra-region field variances may not be available or may not be calculated (e.g., there are too few properties with an observation of the corresponding value). For example, if the GLA variance and the lot size variance cannot be determined, the size score (which depends on the GLA variance and the lot size variance) and its associated size threshold score may be omitted from the calculation. In such implementations, if the total of the scores (that can be calculated) exceeds the total of the associated threshold scores, the region is considered low variance. In some implementations, the total score can be based on a weighted average of the scores (e.g., the size score, value score, and/or the age score), and the total threshold can be based on a corresponding weighted average of the thresholds (e.g., size, value, and age thresholds).

In some implementations, the subject real estate property can be compared to the statistical characteristics at least some of the other regions (e.g., the low variance regions) to determine which of the regions are a match to the subject property. For example, a similarity score can be calculated to determine how similar a particular region is to the subject property. In some cases, the higher the similarity score, the more the region is similar to the subject property. The similarity score can be based at least partly on one or more region scores (e.g., size, value, and/or age scores), one or more mean values for various fields, one or more standard deviations for the various fields, etc.

In some cases, for some or all of the fields, a z-score can be calculated that compares the subject property to the corresponding mean field value for the region. The z-score can be calculated as

$$z = ( \frac{p - \overline{x}}{s} ) ,$$

where x̅ is the mean of a region's field value, p is the corresponding value for the subject property, and s is the standard deviation of the region's field value.

In some such cases, a field value for the subject property can be compared to the mean field value for a region to determine whether the region is a statistical match to the subject property. In some contexts, the term “difference” is used to mean a measure of the statistical variance between the subject property and the region. The level of statistical variance can be used to categorize the fields into low, medium, and high difference. For example, the difference between the values of a field for the subject property and a region can be calculated and compared to the thresholds in Table 1 (the Variance Table) to determine whether to categorize the difference as low, medium, or high. In some cases, the values in Table 1 are multiplied by a factor (e.g., 2), for example, to broaden the example ranges shown in Table 1, which may generate more linkage between the regions and the subject property.

In some implementations, additional factors can be considered when categorizing the level of variance between the subject property and a region. For example, in some such implementations, the subject property's z-score must be in a first range (e.g., −0.4 and +0.4) for the difference to be categorized as low, the subject property's z-score must be in a second range (e.g., −0.7 and +0.7) for the difference to be categorized as medium, and the subject property's z-score must be in a third range (e.g., outside the range from −0.7 to +0.7) for the difference to be categorized as high.

Size, age, and/or value scores for the subject property and a region can be calculated similarly to the region scores discussed above. For example, for one or more fields, a variance score can be multiplied by a variance weight, and these products can be summed. If the total score exceeds an associated threshold, the region is considered a match for the subject property. Comparables can be selected from matching regions.

In some implementations, if one or more matching region(s) are located adjacent to the subject property, and they are contiguous, comparables can be selected from this contiguous group of matching regions. In some such implementations, contiguous region(s) in the geographic area are searched for “inside-out”. For example, the methods and systems can start at the subject property or a region located near the center of the geographic area and work outwards toward a boundary to identify regions that are matches to the subject property. In other implementations, other contiguous region algorithms can be used (e.g., a flood-fill algorithm). For example, a four-way checking algorithm can be used that examines horizontally and vertically adjacent regions for contiguity (e.g., sufficiently close matches to the property characteristics of the subject property and/or previously identified contiguous regions) or an eight-way checking algorithm can be used that checks horizontally, vertically, and diagonally adjacent regions for contiguity.

In some implementations, if the combined size, age, and value scores cannot identify similar regions to the subject, only the value scores and associated value thresholds may be used to find similar region(s) to the subject property. If this process does not identify similar region(s), then only the size scores and associated size thresholds may be used to find similar region(s). If this process also does not identify similar region(s), the age scores and associated age thresholds may be used. If no similar region(s) are identified by the foregoing processes, comparables may be selected from regions or groups of regions that have low intra-region variance and are not too different in size, value, and/or age compared to the subject property. If no such regions or groups of regions can be found, comparables can be selected from the overall geographic area.

In the foregoing example, certain values for thresholds, ranges, weightings, and so forth were provided. These values are intended to be illustrative and not limiting. In other implementations, different values can be used. Further, statistical experiments using real data can be run, and the various values can be determined from these statistical experiments (e.g., via optimization procedures).

### CONCLUSION

Although the foregoing illustrative examples were described in the context of systems and methods for selecting comparable properties for use with AVM valuations, this is not a limitation, and the systems and methods described herein can also be used in other applications. As one example, the comparable properties can represent residential or commercial properties. As another example, implementations of the disclosed systems and methods can be used to identify and select comparable properties for use in market analyses performed by real estate or mortgage brokers, property appraisers, lenders, or banks.

Each of the processes, methods, and algorithms described herein and/or depicted in the attached figures may be embodied in, and fully or partially automated by, code modules executed by one or more physical computing systems, hardware computer processors, application-specific circuitry, and/or electronic hardware configured to execute computer instructions. For example, computing systems can include general or special purpose computers, servers, desktop computers, laptop or notebook computers or tablets, personal mobile computing devices, mobile telephones, and so forth. A code module may be compiled and linked into an executable program, installed in a dynamic link library, or may be written in an interpreted programming language.

Various embodiments have been described in terms of the functionality of such embodiments in view of the general interchangeability of hardware and software. Whether such functionality is implemented in application-specific hardware or in software executing on one or more physical computing devices depends upon the particular application and design constraints imposed on the overall system. Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time.

Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed processes or process steps may be stored, persistently or otherwise, in any type of non-transitory, tangible computer storage or may be communicated via a computer-readable transmission medium.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” and “an” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The foregoing disclosure, for purpose of explanation, has been described with reference to specific embodiments, applications, and use cases. However, the illustrative discussions herein are not intended to be exhaustive or to limit the inventions to the precise forms disclosed. Many modifications and variations are possible in view of the above teachings. The embodiments were chosen and described in order to explain the principles of the inventions and their practical applications, to thereby enable others skilled in the art to utilize the inventions and various embodiments with various modifications as are suited to the particular use contemplated.

What is claimed is:

1. A method for selecting real estate properties that are comparable to a subject real estate property, the method comprising:
under control of a computer system comprising a physical computing device in communication with at least one nontransitory data repository:
receiving, by the computing device from the at least one data repository through a network communication channel, information about the subject real estate property, the information including at least a location of the subject real estate property;
mapping, by the computing device, a geographic area surrounding the location of the subject real estate property into a plurality of regions;
determining, by the computing device, for each of the plurality of regions, a regional statistical characteristic of properties located in the respective plurality of regions;
determining, by the computing device, based at least in part on the respective regional statistical characteristics and the information about the subject property, a set of one or more regions that match the subject real estate property;
selecting, by the computing device, comparable properties from the set of one or more matched regions; and
providing, through the network communication channel, the selected comparable properties to an entity.

2. The method of claim 1, wherein the information about the subject real estate property further includes one or more of gross living area, lot size, price per square foot, assessed value, year built, number of bedrooms or bathrooms, presence of improvements or amenities, a prior sales price, or a prior sales price adjusted to reflect a target valuation date.

3. The method of claim 1, wherein mapping the geographic area surrounding the location of the subject real estate property into the plurality of regions comprises dynamically adjusting the geographic area until a total number of properties in the geographic area exceeds a threshold.

4. The method of claim 1, wherein mapping the geographic area surrounding the location of the subject real estate property into the plurality of regions comprises using a tiling or tessellation algorithm to determine the plurality of regions.

5. The method of claim 1, wherein an area of at least a first region located near the subject real estate property is smaller than an area of at least a second region located farther from the subject real estate property than the first region.

6. The method of claim 1, wherein a shape of at least one of the plurality of regions is a polygon.

7. The method of claim 1, wherein mapping the geographic area surrounding the location of the subject real estate property into the plurality of regions comprises dynamically adjusting a number of the plurality of regions based at least partly on a number of properties in the geographic area.

8. The method of claim 1, wherein determining the regional statistical characteristic of properties located in the respective plurality of regions comprises determining a mean, a median, a mode, a skewness, a variance, or a standard deviation of one or more of sales prices, listing prices, gross living area, lot size, price per square foot, assessed value, year built, number of bedrooms or bathrooms, or presence of improvements or amenities for properties in the region.

9. The method of claim 8, further comprising adjusting the sales prices or the listing prices to reflect a target valuation date.

10. The method of claim 1, wherein determining the regional statistical characteristic of properties located in the respective plurality of regions comprises determining a regional score based at least partly on a plurality of property characteristics.

11. The method of claim 1, wherein determining the set of one or more regions that match the subject real estate property comprises determining a variance between a first statistical characteristic of a first region and a second statistical characteristic of a second region different from the first region or determining a variance between the first statistical characteristic of the first region and a corresponding characteristic of the subject real estate property.

12. The method of claim 11, further comprising determining whether the variance is below a threshold.

13. The method of claim 1, wherein determining the set of one or more regions that match the subject real estate property comprises weighting or ranking the regions based at least partly on an intra-region variance of the statistical characteristics of properties located within the respective region.

14. The method of claim 13, wherein selecting the comparable properties from the set of one or more regions comprises preferentially selecting comparable properties from regions with higher weightings or rankings than from regions with lower weightings or rankings.

15. The method of claim 1, wherein determining the set of one or more of the plurality of regions that match the subject real estate property comprises identifying a plurality of contiguous regions that include or intersect the location of the subject real estate property.

16. The method of claim 15, wherein selecting the comparable properties from the set of one or more regions comprises selecting comparable properties from the plurality of contiguous regions.

17. The method of claim 1, further comprising providing a graphical representation of that patterns that are indicative of how closely a region matches statistical characteristics of another region or the subject real estate property.

18. The method of claim 1, wherein the properties located in the respective plurality of regions comprises properties for which a property valuation has been made during a preceding time period.

19. The method of claim 1, wherein providing the selected comparable properties to an entity comprises communicating the selected comparable properties to an automated valuation model (AVM) for valuation of the subject real estate property.

20. A method for selecting real estate properties that are comparable to a subject real estate property, the method comprising:
under control of a computer system comprising a physical computing device in communication with at least one nontransitory data repository:
receiving, by the computing device from the at least one data repository through a network communication channel, information about the subject real estate property, the information including at least a location of the subject real estate property;
mapping, by the computing device, a geographic area surrounding the location of the subject real estate property into a plurality of regions;
determining, by the computing device, for each of the plurality of regions, a regional statistical characteristic of properties located in the respective plurality of regions;
analyzing, by the computing device, the regional statistical characteristics to determine patterns indicative of how closely a region matches statistical characteristics of another region;
grouping, by the computing device, the plurality of regions into one or more pattern groups based at least in part on the determined patterns;
comparing, by the computing device, the one or more pattern groups with the subject real estate property to determine a set of one or more pattern groups that most closely match the subject real estate property;
selecting, by the computing device, comparable properties from the set of one or more pattern groups that most closely match the subject real estate property; and
providing, through the network communication channel, the selected comparable properties to an entity.

21. The method of claim 20, wherein mapping the geographic area surrounding the location of the subject real estate property into the plurality of regions comprises using a tiling or tessellation algorithm to determine the plurality of regions.

22. The method of claim 20, wherein mapping the geographic area surrounding the location of the subject real estate property into the plurality of regions comprises dynamically adjusting a number of the plurality of regions based at least partly on a number of properties in the geographic area.

23. The method of claim 20, wherein determining the regional statistical characteristic of properties located in the respective plurality of regions comprises determining a mean, a median, a mode, a skewness, a variance, or a standard deviation of one or more of sales prices, listing prices, gross living area, lot size, price per square foot, assessed value, year built, number of bedrooms or bathrooms, or presence of improvements or amenities for properties in the region.

24. The method of claim 20, wherein determining the regional statistical characteristic of properties located in the respective plurality of regions comprises determining a regional score based at least partly on a plurality of property characteristics.

25. The method of claim 20, wherein analyzing the regional statistical characteristics to determine patterns indicative of how closely a region matches statistical characteristics of another region comprises determining a variance between a first statistical characteristic of a first region and a second statistical characteristic of a second region different from the first region or determining a variance between the first statistical characteristic of the first region and a corresponding characteristic of the subject real estate property.

26. The method of claim 20, wherein grouping the plurality of regions into one or more pattern groups based at least in part on the determined patterns comprises identifying a plurality of contiguous regions that include or intersect the location of the subject real estate property.

27. The method of claim 26, wherein selecting comparable properties from the set of one or more pattern groups that most closely match the subject real estate property comprises selecting comparable properties from the plurality of contiguous regions.

28. The method of claim 20, wherein providing the selected comparable properties to an entity comprises communicating the selected comparable properties to an automated valuation model (AVM) for valuation of the subject real estate property.
